(19) United States
(12) Patent Application Publication
(10) Pub. No.: US 2019/0289392 A1
(43) Pub. Date: Sep. 19, 2019

(54) CABLING ASSEMBLY

(71) Applicant: NEUTRIK AG, Schaan (LI)

(72) Inventor: Michael Fuchsl, Dornbirn (AT)

(73) Assignee: NEUTRIK AG, Schaan (LI)

(21) Appl. No.: 16/317,678

(22) PCT Filed: Jul. 18, 2017
(86) PCT No.: PCT/EP2017/068155

§ 371 Date: Jan. 14, 2019

(30) Foreign Application Priority Data
Jul. 27, 2016 (DE) 10 2016 113 831.2

(51) Int. Cl. H04R 3/00; H04R 5/04

(52) U.S. Cl. CPC H04R 3/005; H04R 5/04

(57) ABSTRACT

A cabling assembly for connecting multiple microphones and/or instruments to a mixer, wherein the cabling assembly has a multi-channel connection cable with at least one multi-channel cable connection that can be connected directly or indirectly to the mixer, wherein the cabling assembly has at least one series of connection units, wherein at least some of the connection units, preferably every connection unit, has at least one signal input for connecting a microphone and/or instrument, and at least one multi-channel connection line input and at least one multi-channel connection line output, wherein a first of the connection units is connected to the connection cable by the connection line input thereof, and the other connection units, preferably all the other connection units, are connected to the connection line output of the first connection unit by multi-channel connection cables in a row behind one another.

### BACKGROUND

The present invention relates to a cabling assembly for connecting a plurality of microphones and/or instruments to a mixer, wherein the cabling assembly comprises a multi-channel connection cable having at least one multi-channel cable connection that can be connected directly or indirectly to the mixer.

Generic cabling assemblies are employed for connecting a plurality of microphones and/or instruments to a mixer. In the prior art, known cabling assemblies of this type comprise a central merge unit having a plurality of signal inputs combined in a single housing for the connection of microphones and/or instruments. As they are generally arranged at a central point on a stage, they are also described as “stage boxes”. From a central merge unit of this type, a multi-channel connection cable is then routed to the mixer.

This cabling assembly known from the prior art has a disadvantage in that it requires a separate cable to be routed from each microphone and/or instrument to the merge unit or stage box, in a star-connected arrangement. This generally results in a plurality of cables which require routing to the merge unit, and which must be arranged in any given layout on a stage or similar. In addition to the complexity of the layout, the plurality of cables naturally also exacerbates the hazard of tripping and similar.

### SUMMARY

The object of the invention, with respect hereto, is to provide an improved cabling assembly.

According to the invention, a cabling assembly is provided for the solution of this problem having one or more features of the invention.

A cabling assembly of this type according to the invention is thus characterized in that the cabling assembly comprises at least one series of connection units, wherein at least a number of the connection units, preferably every connection unit, has at least one signal input for connecting a microphone and/or instrument, at least one multi-channel connection line input, and at least one multi-channel connection line output, wherein a first of the connection units is connected to the connection cable by the connection line input thereof, and the other, preferably all the other, connection units are connected to the connection line output of the first connection unit, by multi-channel linking cables, in a row one behind another.

By use of the invention, it is now no longer necessary for a separate cable to be routed from each microphone and/or instrument to a merge unit or stage box which is centrally arranged on the stage. Instead, by the use of the series of connection units, it is possible for the individual microphones and/or instruments to be connected, in a decentralized manner, to a respective connection unit arranged in the vicinity thereof. The term instrument is primarily to be understood here as any kind of musical instrument.

The first of the connection units, via its connection line input, is connected by the multi-channel connection cable to the mixer. This connection to the mixer can be executed directly or indirectly. To this end, the multi-channel connection cable can comprise a single cable connection. However, the connection cable, on the end thereof which is averted from the first of the connection units, can also be fanned-out, and can comprise a plurality of cable connections, which are then correspondingly connected to the mixer. If the multi-channel connection cable is connected directly to the mixer, the cable connection(s) is (are) thus directly connected to the mixer. However, it can also be the case that the multi-channel connection cable is firstly connected to an extension cable or to another merge unit, e.g. on the stage, and the further connection to the mixer is then completed via a corresponding extension cable, or at least one cable between the merge unit and the mixer. In this case, the multi-channel connection cable is then connected indirectly to the mixer. The series of the connection units connected in a row, one behind another, in the cabling assembly according to the invention comprises at least two connection units. This minimal configuration thus comprises the first and a last connection unit. In general, however, the cabling assembly according to the invention comprises more than two connection units such that, in general, a plurality of further connection units are also located in the row between the first connection unit and the last connection unit. Each of these connection units has at least one signal input for connecting a microphone and/or an instrument, and at least one multi-channel connection line input. Up to the last connection unit in the row, all the connection units advantageously additionally also incorporate a connection line output. In the last of the connection units in the row, the connection line output could, in principle, be omitted. In preferred forms of embodiment of the cabling assembly, however, all the connection units are of identical construction. Preferably, all the connection units also incorporate a connection line output. Accordingly, in the constitution of the cabling assembly by interconnection of the connection units, the linking cables and the connection cable, it does not need to be considered which of the connection units is employed as the last connection unit in the row. Each connection unit advantageously comprises a dedicated housing, in which the signal input, the connection line input and, in general, also the connection line output, and preferably also the channel selector switch described hereinafter, are arranged or combined.

Cabling assemblies according to the invention comprise at least one row of connection units, connected and arranged one behind another. However, this does not exclude arrangements whereby the cabling arrangement can also comprise a plurality of rows of connection units. These might even be interconnected in parallel.

The connection units could also be described as connection boxes.

In particularly preferred forms of embodiment of the cabling assembly, it is provided that, in the row of connection units connected one behind another, the connection line input of any of the respective connection units, by one of the linking cables, is connected to the connection line output of the preceding connection unit arranged in the row.

Cabling assemblies according to the invention permit the connection units, in the fully-connected state, to be arranged at a distance from one another. Accordingly, it is possible for the respective connection unit to be respectively arranged in the vicinity of the microphone or instrument which is to be connected to the mixer by said connection unit. The maximum possible distance between two of the connection units is thus dictated by the length of the linking cable(s) for the interconnection thereof.

On the signal input of at least one of the connection units, preferably of all the connection units, it is preferably provided that said input comprises at least two signal channels. One of the signal channels can carry the ground potential, thereby constituting an earthing channel. It can also be provided, however, that the signal input, additionally to the two signal channels, also further comprises a separate earthing channel. This can be connected e.g. to a corresponding shielding or to a corresponding grounding channel of a corresponding connector and/or connection cable and/or connection line input and/or connection line output. The terms earthing channel and grounding channel are employed for the purposes of linguistic distinction. In physical terms, however, there is one earth connection or one ground connection respectively.

The multi-channel connection cable and the multi-channel linking cables, preferably each of these multi-channel linking cables, in preferred forms of embodiment, respectively comprise the same number of channels and/or grounding channels. As a result, it is again immaterial which of the linking cables is employed for the connection of which of the connection units in the row. The number of channels in the connection cable and in the respective linking cables, and correspondingly also in the connection line inputs and connection line outputs of the connection units, advantageously corresponds to the product of the total number of signal inputs present in the cabling assembly multiplied by the number of signal channels per signal input. Moreover, in the connection cable, and also in the linking cables, the connection line inputs and the connection line outputs, additionally at least one grounding channel can be provided which, e.g. is connected to a corresponding shielding of the corresponding cable, or is constituted by the latter. Any earthing channels present on the signal inputs can e.g. all be switched on the same grounding channel.

As a signal input of at least one of the connection units, preferably of all the connection units, in preferred forms of embodiment, a two- or three-pole connector can be employed. In this case, this can be e.g. a three-pole standard XLR connector. Alternatively, as a signal input e.g. a jack plug, or a YMS or maxCon connector produced by the firm Neutrik AG could also be employed. For the constitution of the connection line input and/or the connection line output of the respective connection units, recourse is also advantageously made to standard plug-in connectors of the type known from the prior art. It is particularly preferably provided that the connection line input and/or the connection line output of at least one of the connection units, preferably of all the connection units, is a multi-pole connector, preferably a multi-pole XLR connector, or a multi-pole RJ45 connector. If the connection cable comprises only one cable connection, the same multi-pole connector in preferred forms of embodiment can be employed for this purpose as for the connection line inputs and/or connection line outputs. If the connection cable comprises a plurality of cable connections, these cable connections can again be two- or three-pole plug-in connectors, such as e.g. three-pole standard XLR connectors.

In principle, it can be provided that, in each of the connection units, the signal channels of the signal inputs are connected to the corresponding channels of the connection line input and/or connection line output in a fixed manner. However, according to flexibly deployable solutions, at least a number of the connection units, preferably each of the connection units, comprises a channel selector switch, by which it can be set with which channel or channels of the connection line input of the respective connection unit the signal input of the respective connection unit is connected. As a result, it is possible to arrange the respective connection unit at any desired position in the row of connection units. By use of the channel selector switch, appropriate contacting can then be established between signal channels of the signal input and the corresponding channels in the connection line output and/or connection line input of the respective connection unit.

Additionally to the cable assembly according to the invention, the invention further relates to a connection unit for a cabling assembly, for the direct or indirect connection of a plurality of microphones and/or instruments to a mixer. It is particularly preferred that this is a connection unit for a cabling assembly according to the invention of the above-mentioned type. In these connection units, in any event, it is provided according to the invention that the connection unit comprises at least one signal input for the connection of a microphone and/or instrument, and at least one multi-channel connection line input and preferably at least one multi-channel connection line output. In principle, the connection units according to the invention can assume all the forms of embodiment described above with reference to the cabling assembly according to the invention. It is particularly advantageous, however, if the connection unit according to the invention comprises at least one channel selector switch, by which it can be set to which channel or channels of the connection line input of the connection unit the signal input of the connection unit is connected.

### BRIEF DESCRIPTION OF THE DRAWINGS

Further characteristics and details of preferred forms of embodiment of the invention are described hereinafter with reference to exemplary embodiments. In the figures:

FIG. 1 shows a schematic layout of a cabling assembly according to the invention;

FIGS. 2 and 3 show a first exemplary embodiment of a connection unit according to the invention;

FIGS. 4 to 6 show a second exemplary embodiment of a connection unit according to the invention, and

FIGS. 7 and 8 show a circuit layout diagram of the connection unit according to the invention, in two different circuit states.

### DETAILED DESCRIPTION

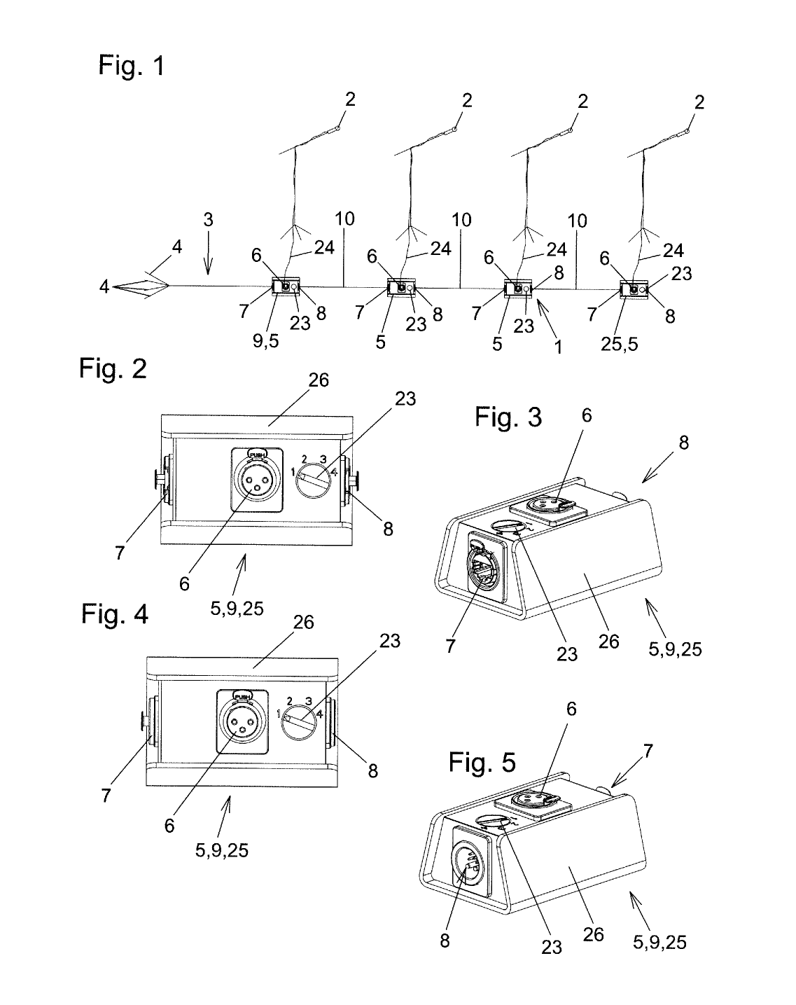

In the schematic representation according to FIG. 1, four microphones 2 are connected by the cabling assembly 1 according to the invention. The number of four microphones has naturally been selected for purely exemplary purposes. By use of a corresponding number of connection units 5 or signal inputs 6, the number of microphones 2 which can be directly or indirectly connected to a mixer, which is not represented here, by the cabling assembly 1 according to the invention can be varied virtually at will.

In the interests of completeness, it is hereby indicated that, in place of the microphones 2 and/or additionally thereto, instruments, which are not explicitly represented here, can naturally also be connected in the same manner to the signal inputs 6 of the connection units 5, 9, 25.

In the exemplary embodiment represented, each connection unit 5, 9, 25 comprises exactly one signal input 6. This is also not necessarily the case. As already described above, individual connection units 5, 9, 25 can also comprise more than one signal input 6. The microphones 2 or instruments are respectively connected via microphone or instrument cables 24 to the signal input 6 of a respective connection unit 5, 9, 25. The connection units 5, 9, 25 are arranged at a distance from one another, and are connected one behind another in a row. The first connection unit 5 additionally carries the reference number 9. The final connection unit 5 in the row additionally carries the reference number 25. However, in the exemplary embodiment represented, as also in other preferred exemplary embodiments, all the connection units 5, 9 and 25 are of identical design, such that the sequence thereof can also be mutually interchanged. In this exemplary embodiment, each connection unit 5, 9 and 25 comprises a signal input 6 for the connection of a microphone 2 and/or of an instrument, a multi-channel connection line input 7 and a multi-channel connection line output 8. The multi-channel connection cable 3 is connected to the connection line input 7 of the first connection unit 9. At the opposite end, the multi-channel connection cable 3 is fanned-out, and is provided with a plurality of multi-channel cable connections 4. These cable connections 4 can correspondingly be connected directly to a mixer or similar. It is equally possible, as already described above, for the cable connections 4 to be firstly connected to a merge unit, an extension cable or similar. By the connection of the merge unit, which is not represented here, or of the here likewise unrepresented extension cable to the corresponding mixer, the cable assembly 1 according to the invention represented here is then indirectly connected or connectable to a mixer, which is not represented here. In the exemplary embodiment represented, the connection cable 3 is fanned-out into the cable connections 4 such that an individual signal input 6 of an individual connection unit 5 can be assigned to each cable connection 4. This is described in further detail hereinafter with reference to FIGS. 7 and 8. In the exemplary embodiment represented here, for example, each cable connection 4 could be configured as a three-pole connector such as e.g. a three-pole XLR connector.

In a departure from the above, it might also be provided that a single cable connection 4 is assigned to the multi-channel connection cable 3, rather than a plurality of cable connections 4. In turn, this might involve a multi-pole connector having a correspondingly large number of poles or channels. In these forms of embodiment, the cable connection 4 might be configured e.g. as a corresponding multi-pole XLR connector, or a corresponding multi-pole RJ45 connector.

If, in the exemplary embodiment represented, the row of connection units 5, 9, 25 connected one behind another is considered, the connection line input 7 of a respective connection unit 5, 25 is connected by a linking cable 10 to the connection line output 8 of the connection unit 5, 9 arranged ahead thereof in the row. With the exception of the final connection unit 25 in the row, considered the other way round, the respective connection line outputs 8 are respectively connected by a linking cable 10 to the respective connection line input 7 of the connection unit 5, 9 arranged to the rear thereof in the row. In the exemplary embodiment represented, the connection line output 8 of the final connection unit 25 correspondingly remains unoccupied. Naturally, a corresponding connection line output 8 could also be entirely omitted from the final connection unit 25. However, the advantage would then no longer then apply, wherein all the connection units 5, 9 and 25 are configured to an identical design, such that the sequence thereof can be interchanged.

Additionally, in the exemplary embodiment represented, a channel selector switch 23 is assigned to each connection unit 5. The function thereof is described in detail hereinafter, with reference to FIGS. 7 and 8.

FIGS. 2 and 3 show a first exemplary embodiment of a connection unit 5, or 9, or 25, which can be employed in the layout according to FIG. 1. This connection unit 5, 9, 25 comprises a dedicated housing 26, in which the signal input 6, the connection line input 7 and the connection line output 8 are arranged in combination with one another in a single unit. In this case, the channel selector switch 23 is additionally also integrated in the housing 26. The connection unit 5, 9, 25 thus constitutes an independent closed unit, which can be installed at any desired location. Correspondingly, reference might also be made to a connection box, rather than a connection unit 5, 9, 25.

In the exemplary embodiment, the signal input 6 is configured as a three-pole XLR chassis connector, of the type which is commercially available nowadays. In this exemplary embodiment, according to FIGS. 2 and 3, the connection line input 7 and the connection line output 8 are respectively RJ45 connectors of identical design, of the type which are also available on the market. In this exemplary embodiment, standard, and preferably shielded, ethernet cable can be employed for the linking cables 10 and, where applicable, additionally for the connection cable 3. The interconnection of the connection line input 7, the connection line output 8, the signal input 6 and the channel selector switch 23 assigned to the connection unit 5 is described in greater detail hereinafter with reference to FIGS. 7 and 8.

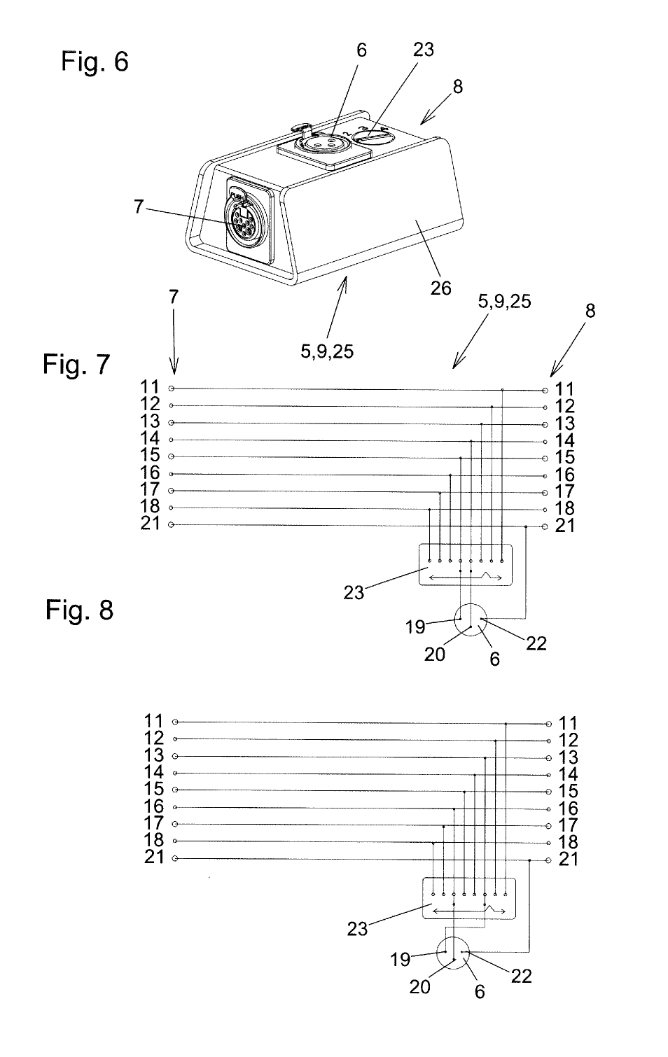

FIGS. 4, 5 and 6 represent an alternative form of embodiment of corresponding connection units 5, 9 and 25. The only difference from the exemplary embodiment according to FIGS. 2 and 3 is that different multi-pole connectors are employed as the connection line input 7 and the connection line output 8. In this exemplary embodiment according to FIGS. 4, 5 and 6, the connection line input 7 is a female multi-pole XLR chassis connector. The connection line output 8 is configured as a corresponding multi-pole male XLR chassis connector. The number of channels or poles of the connection line input 7 and of the connection line output 8 are mutually matched, and match the number of channels in the respective linking cable 10 or also in the connection cable 3, in preferred forms of embodiment such as these. On the connection cable 3 and on the linking cables 10, connector types, which are correspondingly suitable for plugging-together, are respectively arranged as mating components for the connection line input 7 and the connection line output 8. All these multi-pole connectors are freely commercially available, and can naturally also be replaced by other multi-pole connectors which are known from the prior art, or by other connector types.

FIGS. 7 and 8 respectively show exemplary and schematic representations of a circuit layout for the connection of the connection line input 7 to the connection line output 8 within a connection unit 5, via the channels 11 to 18. In the interests of completeness, it is indicated that the channels 11 to 18, together with the grounding channel 21, also extend within the connection unit 5, 9, 25 to the extent that they correspondingly connect the connection line input 7 to the connection line output 8. This is also schematically represented in FIGS. 7 and 8. Where the channel selector switch 23 connects the signal channels 19 and 20, within the connection unit 5, 9, 25, to the respective channels 11 to 18, is immaterial. This connection can be executed directly on the connection line input 7, directly on the connection line output 8, or also in between. Additionally to the channels 11 to 18, this connection unit 5 of the exemplary embodiment represented here further comprises the above-mentioned grounding channel 21, which e.g. can be connected or connectable to a corresponding shielding in the linking cables 10 and the connection cable 3. The linking cables 10 and the connection cable 3 comprise a corresponding number of channels. Each of the channels 11 to 18, and additionally the grounding channel 21, are preferably configured in the form of electrically conductive signal lines e.g. in the form of metal wires, specifically copper wires, or similar. Specifically within the connection units 5, 9, 25, for example, other forms of embodiment of the channels 11 to 18 and of the grounding channel 21, with circuit boards and printed conductors, e.g. of copper, correspondingly arranged thereupon, are also possible. The concept of the channels 11 to 18 is applied here to both the corresponding lines in the connection units 5 and in the linking cables 10, and also in the connection cable 3. A linguistic distinction in this regard is applied to the signal channels 19 and 20 and also to the earthing channel 22, which are respectively assigned to a signal input 6. As can clearly be seen in FIGS. 7 and 8, in the exemplary embodiment represented of the connection unit 5, 9, 25, both of the signal channels 19 and 20 which are assigned to the signal input 6, which can likewise be configured as electrically conductive lines of the above-mentioned type described with reference to the channels 11 to 18, can be switched by the channel selector switch 23 to different pairings of the channels 11 to 18. FIG. 7 represents an exemplary circuit state, in which the signal channels 19 and 20 of the signal input 6 of the connection unit 5, 9, 25 are switched to the channels 14 and 15. FIG. 8 represents an exemplary circuit state, in which the signal channels 19 and 20 of the signal input 6 are switched to the channels 13 and 16. By a corresponding switchover of the channel selector switch 23 of the connection unit 5, the signal channels 19 and 20 of the signal input 6 can thus be switched to different pairs of channels 11 to 18, or connected to the latter. In consideration of FIG. 1, in the exemplary embodiment represented here, it is provided that the signal channels 19 and 20 of the signal input 6 of the first connection unit 9 are switched to the channels 14 and 15. In the next sequential connection unit 5 in the row, by a corresponding setting of the channel selector switch 23 of said connection unit 5, the signal channels 19 and 20 of the signal input 6 are switched to the channels 13 and 16. In the next connection unit 5 in the row, arranged sequentially to the rear, by a corresponding setting of the channel selector switch 23 of said connection unit 5, the signal channels 19 and 20 thereof are switched to the channels 11 and 12. In the final connection unit 25, by a corresponding setting of the channel selector switch 23, the signal channels 19 and 20 of the signal input 6 are switched to the channels 17 and 18. The different switch settings of the channel selector switch 23, as can be seen in FIGS. 2 to 6, can be marked with sequential numbers, or other markings, which are perceptible to the user.

In the exemplary embodiment represented, the earthing channel 22 of each signal input 6, in each connection unit 5, is permanently connected to the respective grounding channel 21.

It is further indicated that, in this exemplary embodiment, in consideration of FIG. 1, a dedicated cable connection 4 is assigned to the channels 14 and 15, a dedicated cable connection 4 is in turn assigned to the channels 13 and 16, a dedicated cable connection 4 is likewise assigned to the channels 11 and 12, and a dedicated cable connection 4 is also assigned to the channels 17 and 18. Accordingly, in the circuit arrangement represented in this exemplary embodiment, a dedicated cable connection 4 is then assigned overall to each microphone 2 for the connection to a corresponding mixer.

In principle, it is indicated that, for the transmission of corresponding audio signals, additionally to the earthing channel 22 or grounding channel 21, respectively at least two channels 11 to 18 and at least two signal channels 19 and 20 are advantageously individually assigned to each microphone 2 or instrument. However, one of the signal channels could also be replaced by the earthing channel 22 and the grounding channel 21. Advantageously, in symmetrical signal transmission, as commonly employed e.g. for microphones 2, respectively two channels 11 to 18 or two signal channels 19 and 20 are employed additionally to the earthing channel 22 or the grounding channel 21 for the transmission of a signal. In asymmetrical signal transmission, as commonly employed for instruments, one of the signal channels 19 or 20 can also be omitted. The signals are then transmitted via a channel 11 to 18 or a signal channel 19 or 20, and the earthing channel 22 or grounding channel 21. Naturally, the number of channels 11 to 18 can be adjusted as required to the number of microphones 2 and/or instruments which are to be connected by the cabling assembly 1 according to the invention. Customarily, the number of channels 11 to 18 corresponds at least to the product of the sum of the signal inputs 6 employed in the cabling assembly 1 and the number of signal channels 19 and/or 20 assigned to each signal input 6.

Switches which are known per se can be employed as channel selector switches 23. These can be slide switches, rotary switches or other switches, e.g. also digitally controllable switches or similar.

### KEY TO REFERENCE NUMBERS

1 Cabling assembly
2 Microphone
3 Connection cable
4 Cable connection
5 Connection unit
6 Signal input
7 Connection line input
8 Connection line output
9 First connection unit
10 Linking cable
11 Channel
12 Channel
13 Channel
14 Channel
15 Channel
16 Channel
17 Channel
18 Channel
19 Signal channel
20 Signal channel
21 Grounding channel
22 Earthing channel
23 Channel selector switch
24 Microphone or instrument cable
25 Final connection unit
26 Housing

1. A cabling assembly for connecting a plurality of microphones and/or instruments to a mixer, the cabling assembly comprises:
a multi-channel connection cable having at least one multi-channel cable connection that is adapted to be directly or indirectly connected to the mixer,
a series of connection units, at least a number of the connection units has at least one signal input adapted for connecting at least one of a microphone or instrument,
at least one multi-channel connection line input,
at least one multi-channel connection line output,
a first of the connection units is connected to the connection cable by the connection line input thereof, and at least one other of the connection units is connected to the connection line output of the first connection unit, by multi-channel linking cables, arranged in a row one behind another.

2. The cabling assembly as claimed in claim 1, wherein, in the row of connection units connected one behind another, the connection line input of any of the respective connection units is connected by one of the linking cables to the connection line output of the preceding connection unit arranged in the row.

3. The cabling assembly as claimed in claim 1, wherein the connection units, in a fully-connected state, are adapted to be arranged at a distance from one another, and a maximum possible distance between two of the connection units is dictated by a length of the linking cable for interconnection thereof.

4. The cabling assembly as claimed in claim 1, wherein the connection cable and the linking cables comprise a same number of channels, a same number of grounding channels, a same number of channels and grounding channels.

5. The cabling assembly as claimed in claim 1, wherein the signal input of at least one of the connection units comprises at least two signal channels.

6. The cabling assembly as claimed in claim 1, wherein at least a number of the connection units comprise a channel selector switch configured to set which channel or channels of the connection line input of the respective connection unit are connected to the signal input of the respective connection unit.

7. The cabling assembly as claimed in claim 1, wherein the signal input of at least one of the connection units is a two- or three-pole connector.

8. The cabling assembly as claimed in claim 1, wherein at least one of the connection line input or the connection line output of at least one of the connection units is a multi-pole connector.

9. A connection unit for a cabling assembly adapted for direct or indirect connection of a plurality of microphones, instruments, or both to a mixer the connection unit comprises at least one signal input adapted for connection of at least on of the microphone or instrument and at least one multi-channel connection line input.

10. The connection unit as claimed in claim 9, further comprising at least one channel selector switch configured to set which channel or channels of the connection line input of the connection unit are connected to the signal input of the connection unit.

11. The cabling assembly as claimed in claim 5, wherein the signal input of at least one of the connection units further comprises an earthing channel.

12. The cabling assembly as claimed in claim 1, wherein the cable connection of the connection cable is a multi-pole connector.

13. The cabling assembly as claimed in claim 9, further comprising at least one multi-channel connection line output.
